(19) United States
(12) Patent Application Publication
(10) Pub. No.: US 2020/0296457 A1
(43) Pub. Date: Sep. 17, 2020

(54) ATTENTION BASED MEDIA CONTROL

(71) Applicant: QUALCOMM Incorporated, San Diego, CA (US)

(72) Inventors: Christopher CHURCH, Cambridge (GB); Jonathan Grenville TANNER, Sidmouth (GB); Laurence George RICHARDSON, Ely (GB); Magnus Sigverth SOMMANSSON, Veberod (SE); Mayank BATRA, Cambridge (GB)

(21) Appl. No.: 16/351,053

(22) Filed: Mar. 12, 2019

(51) Int. Cl. H04N 21/442; H04N 21/6587; G06K 9/00

(52) U.S. Cl. CPC H04N 21/44218; G06K 9/00604; G06K 9/00228; H04N 21/6587

(57) ABSTRACT

Systems and methods for monitoring eye movement of a viewer may enable monitoring of a viewer's focus to enhance attention based media control. One example includes providing visual stimuli on a screen, monitoring a viewing focus of a viewer to determine if the viewing focus of the viewer is on the visual stimuli and may include stopping the visual stimuli when the viewing focus is determined to be other than on the visual stimuli. The method may also include resuming the visual stimuli when the viewing focus is determined to be on the visual stimuli.

### FIELD OF DISCLOSURE

This disclosure relates generally to attention based media control, and more specifically, but not exclusively, to media control based on a viewer's focus.

### BACKGROUND

Visual presentation of information is a common occurrence in today's society. Presentation of visual information includes such things as visually advertising a product, term and conditions of legal contracts, and teaching various subject matter to name just a few. More effective visual presentation of information is a constant goal. Maintaining a viewer's focus on the visual presentation is important since visual presentations are always more effective if you can maintain a viewer's focus during the presentation. For instance, visual advertising is more effective when it is viewed by a user, verifying a viewer has viewed the terms and conditions of a contract increase compliance as well as enforcement of the contract, and viewer attention is necessary for multiple sets of visual information where the latter parts need understanding of the former parts.

Presentation of information on a website is also common and effective as long as you. can get the viewer to pay attention to the visual presentation. This is especially true in today's multi-tasking society where a viewer encounters many distractions that may cause the viewer to focus on other visual stimuli. For example, many websites do not enforce a subscription on visitors, but show advertising to support the cost of maintaining the website. The advertisements may include popups, interstitial websites, and video windows. However, the viewer may resist viewing the advertisement using ad blockers to stop popups from appearing or viewers click on the ‘close window’ icon to close the popup without viewing, closing new windows when the viewer is transported away to different sites, or switching to a different tab/window when a video window opens.

Accordingly, there is a need for systems, apparatus, and methods that allow media control of the visual stimuli based on the attention or focus of the viewer to overcome the deficiencies of conventional approaches including the methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented. below.

In one aspect, a method for monitoring eye movement of a viewer includes: presenting visual stimuli on a screen; monitoring a viewing focus of a viewer; determining if the viewing focus of the viewer is on the visual stimuli; stopping the presenting the visual stimuli when the viewing focus is determined to be other than on the visual stimuli; and resuming the presenting the visual stimuli when the viewing focus is determined to be on the visual stimuli.

In another aspect, a non-transitory computer-readable medium comprises instructions that when executed by a processor cause the processor to perform a method that includes: presenting visual stimuli on a screen; monitoring a viewing focus of a viewer; determining if the viewing focus of the viewer is on the visual stimuli; stopping the presenting visual stimuli when the viewing focus is determined to be other than on the visual stimuli; and resuming the presenting the visual stimuli when the viewing focus is determined to be on the visual stimuli.

In still another aspect, an apparatus for monitoring eye movement of a viewer includes: a memory; a processor coupled to the memory; a screen coupled to the processor; a sensor coupled to the processor; wherein the processor is configured to: present visual stimuli on the screen; monitor a viewing focus of a viewer with the sensor; determine if the viewing focus of the viewer is on the visual stimuli; stop the presentation of the visual stimuli when the viewing focus is determined to be other than on the visual stimuli; and resume the presentation of the visual stimuli when the viewing focus is determined to be on the visual stimuli.

In still another aspect, an apparatus for monitoring eye movement of a viewer includes: a memory; means for computing coupled to the memory; means for displaying coupled to the means for computing; means for sensing coupled to the means for computing; wherein the means for computing is configured to: present visual stimuli on the means for displaying; monitor a viewing focus of a viewer with the means for sensing; determine if the viewing focus of the viewer is on the visual stimuli; stop the presentation of the visual stimuli when the viewing focus is determined to he other than on the visual stimuli; and resume the presentation of the visual stimuli when the viewing focus is determined to be on the visual stimuli.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary partial method for monitoring eye movement of a viewer in accordance with some examples of the disclosure;

FIG. 2 illustrates an exemplary apparatus for monitoring eye movement of a viewer in accordance with some examples of the disclosure;

FIG. 3 illustrates an exemplary mobile device in accordance with some examples of the disclosure; and

FIG. 4 illustrates various electronic devices that may he integrated with any of the aforementioned systems, methods, or apparatus in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein mitigate shortcomings of the conventional methods, apparatus, and systems, as well as other previously unidentified needs. In sonic examples herein, attention based media control may use optical hardware to track a subject's vision, provide software hooks to base decisions on (e.g., continue presentation, stop presentation, and resume presentation etc.). In other examples, attention based media control may use software based facial detection in regular cameras in computing devices, such as desktop computers, notebooks, laptops, and smartphones. Facial recognition may allow the systems and methods to detect if a face/person is looking at the screen of the computing device. The use of well-known two dimensional and three dimensional facial mapping systems may enhance the functionality by, for example, restricting the presentation of sensitive, confidential, or secure information to only authorized viewers and presenting the visual information only when an authorized viewer is recognized and focused on the visual presentation. In some examples, the computing system may allow applications to access software hooks to constrain next steps in the presentation: Advert: IF {face_detection=false} OR IF {face_detection=true AND eyes elsewhere=true} THEN pause. Attention based media control may also alert the viewer when the viewer is determined to no longer be focused on the visual stimuli (“the media will resume when you resume watching”) and continue when the viewer's focus has returned to the visual stimuli (such as for required reading): WHILE {face_detection=true} DO enable_continue. This alert or notice may be a visual notice, an audio notice, or a tactile sensation (e.g., a vibration produced by a transducer, heat, cold, etc.).

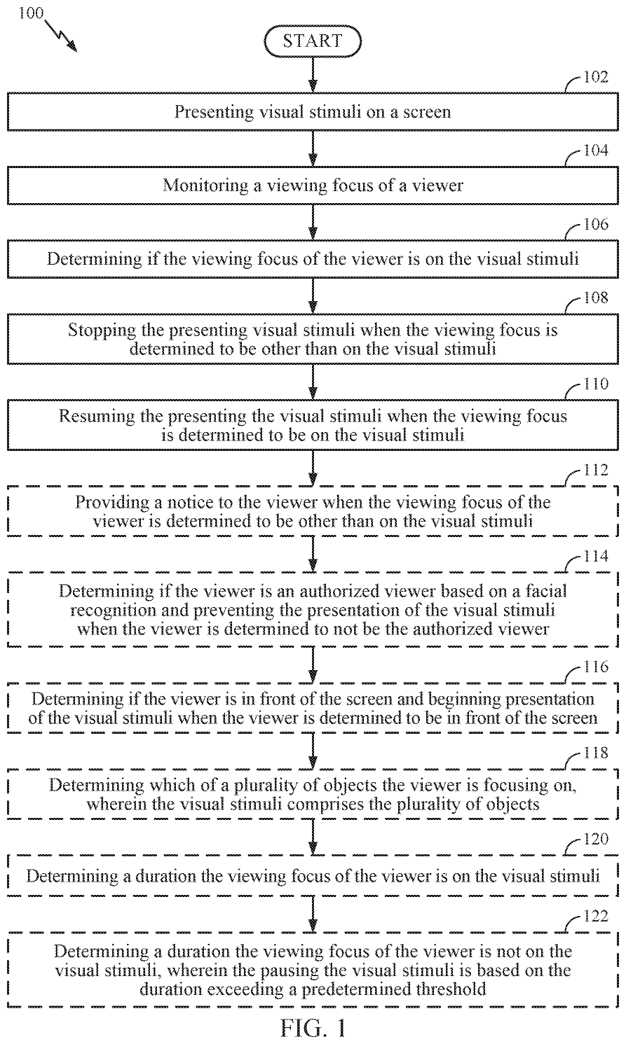

FIG. 1 illustrates an exemplary partial method for monitoring eye movement of a viewer in accordance with some examples of the disclosure. As shown in FIG. 1, the partial method 100 may begin in block 102 with presenting visual stimuli on a screen. The partial method 100 may continue in block 104 with monitoring a viewing focus of a viewer. The partial method 100 may continue in block 106 with determining if the viewing focus of the viewer is on the visual stimuli. The partial method 100 may continue in block 108 with stopping (or pausing) the presenting the visual stimuli when the viewing focus is determined to be other than on the visual stimuli. The partial method 100 may conclude in block 110 with resuming the presenting the visual stimuli when the viewing focus is determined to be on the visual stimuli.

In other alternatives, the partial method 100 may also include one or more of block 112 with providing a notice to the viewer when the viewing focus of the viewer is determined to be other than on the visual stimuli; block 114 with determining if the viewer is an authorized viewer based on a facial recognition and preventing the presentation of the visual stimuli when the viewer is determined to not be the authorized viewer; block 116 with determining if the viewer is in front of the screen and beginning presentation of the visual stimuli when the viewer is determined to be in front of the screen; block 118 with determining which of a plurality of objects the viewer is focusing on, wherein the visual stimuli comprises the plurality of objects; block 120 with determining a duration the viewing focus of the viewer is on the visual stimuli; and block 122 with determining a duration the viewing focus of the viewer is not on the visual stimuli, wherein the stopping the presentation of the visual stimuli is based on the duration exceeding a predetermined threshold. While stop or stopping is used throughout this disclosure, it should be understood that stop or stopping may be pausing with the visual stimuli still displayed, not displayed, displaying a screen saver, scrambling the screen or presentation, displaying a notice that the presentation will only begin when the viewer's focus is returned, or displaying a clock countdown to when the presentation will be stopped completely, resumed only from the beginning, or resume from where the presentation was stopped. Alternatively, a notice, countdown, or warning may be audio and video, video only, or audio only.

These alternatives may provide additional enhancement of attention based media control by alerting a user to return their attention to the display (providing a notice to the viewer), preventing unauthorized viewing of sensitive material (determining if a viewer is an authorized viewer), conserving power (starting the visual stimuli determining if the viewer is in front of the screen), capture additional viewer data (determining which of a plurality of objects the viewer is focusing on and determining a duration the viewing focus of the viewer), and allow momentary distraction of the viewer (determining a duration the viewing focus of the viewer and stopping the presentation of the visual stimuli when the duration exceeds a predetermined threshold, such as 1 second, for example).

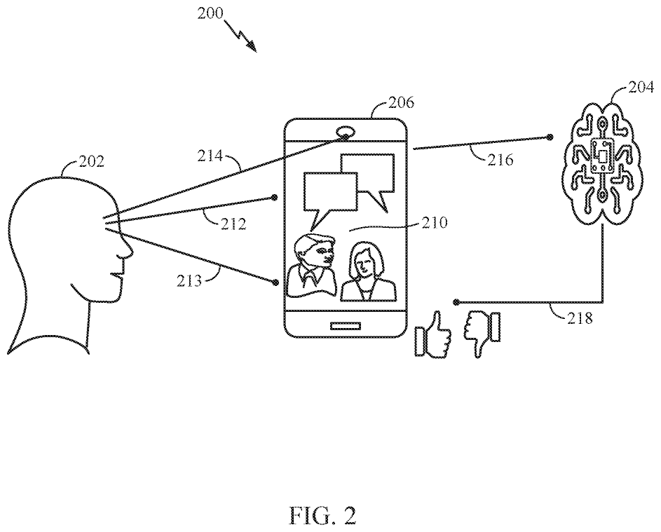

FIG. 2 illustrates an exemplary apparatus for monitoring eye movement of a viewer in accordance with some examples of the disclosure. As shown in FIG. 2, an apparatus 200 (e.g., smartphone) may be configured to monitor the eye movement of a viewer 202. The apparatus 200 may include a memory (not shown), a processor 204 or similar logic, a screen 206 or similar display, and a camera 208 or similar sensor. The apparatus 200 may be configured to perform the method 100 described above. For instance, the apparatus 200 may use the screen 206 to present visual stimuli 210 to the viewer 202. The apparatus 200 may also use camera 208 to detect 212 that the viewer 202 is in front of the screen 206 and perform action 218 such as begin presentation of the visual stimuli 210 when the viewer 202 is determined by the processor 204 to be in front of the screen 206.

The apparatus 200 may also use camera 208 to monitor 214 a viewing focus 213 of the viewer 202. The apparatus 200 may also use the processor 204 to determine 216 if the viewing focus 213 of the viewer 202 is on the visual stimuli 210, perform action 218 such as stop the presentation of the visual stimuli 210 when the viewing focus 213 is determined to be other than on the visual stimuli 210, and perform action 218 such as resume the visual stimuli 210 when the viewing focus 213 is determined to be on the visual stimuli 210. The apparatus 200 may also use the screen 206 (or a speaker to provide an audio alert or a transducer, for example, to provide a tactile sensation) to provide a notice to the viewer 202 when the viewing focus 213 of the viewer 202 is determined to be other than on the visual stimuli 210.

The apparatus 200 may also use the processor 204 to determine if the viewer 202 is an authorized viewer based on a facial recognition and prevent the presentation of the visual stimuli 210 when the viewer 202 is determined to not be the authorized viewer. The apparatus 200 may also use the processor 204 to determine which of a plurality of objects the viewer 202 is focusing on when the visual stimuli 210 includes the plurality of objects. This may be beneficial in determining which objects being displayed are the viewing focus 213 of the viewer 202 and how long the viewer 202 viewed each object by using the processor 202 to determine a duration the viewing focus 213 of the viewer 202 is on the visual stimuli 210 (or a specific object in the visual stimuli 210). The apparatus 200 may also use the processor 204 to determine a duration the viewing focus 213 of the viewer 202 is not on the visual stimuli 210, wherein the visual stimuli 210 may be stopped based on when the duration exceeds a predetermined threshold.

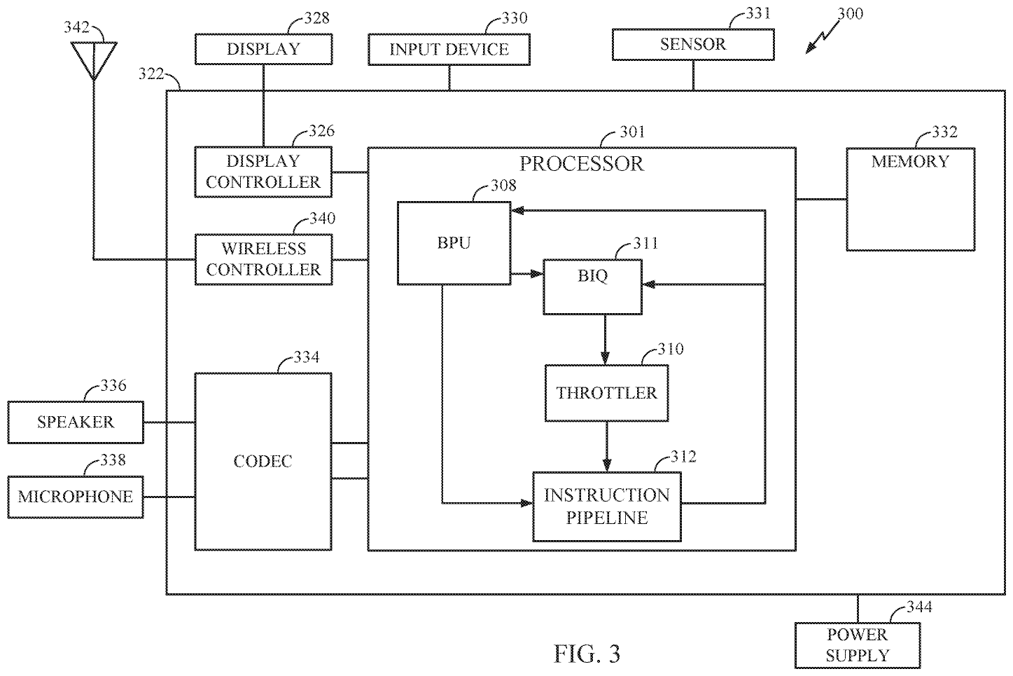

FIG. 3 illustrates an exemplary mobile device in accordance with some examples of the disclosure. Referring now to FIG. 3, a block diagram of a mobile device that is configured according to exemplary aspects is depicted and generally designated 300. In some aspects, mobile device 300 may be configured as a wireless communication device. As shown, mobile device 300 includes processor 301, which may be configured to implement the methods described herein in some aspects. Processor 301 is shown to comprise instruction pipeline 312, buffer processing unit (BPU) 308, branch instruction queue (BIQ) 311, and throttler 310 as is well known in the art. Other well-known details (e.g., counters, entries, confidence fields, weighted sum, comparator, etc.) of these blocks have been omitted from this view of processor 301 for the sake of clarity.

Processor 301 may he communicatively coupled to a sensor 331 (e.g., a camera) and a memory 332 over a link, which may be a die-to-die or chip-to-chip link. Mobile device 300 also includes display 328 (e.g., a screen) and display controller 326, with display controller 326 coupled to processor 301 and to display 328.

In some aspects, mobile device 300 may include coder/decoder (CODEC) 334 (e.g., an audio and/or voice CODEC) coupled to processor 301; speaker 336 and microphone 338 coupled to CODEC 334; and wireless controller 340 (which may include a modem) coupled to wireless antenna 342 and to processor 301.

In a particular aspect, where one or more of the above-mentioned blocks are present, processor 301, display controller 326, memory 332, CODEC 334, and wireless controller 340 can be included in a system-in-package or system-on-chip device 322. Input device 330 (e.g., physical or virtual keyboard), power supply 344 (e.g., battery), display 328, input device 330, speaker 336, microphone 338, wireless antenna 342, and power supply 344 may be external to system-on-chip device 322 and may be coupled to a component of system-on-chip device 322, such as an interface or a controller.

It should be noted that although FIG. 3 depicts a mobile device 300, processor 301 and memory 332 may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

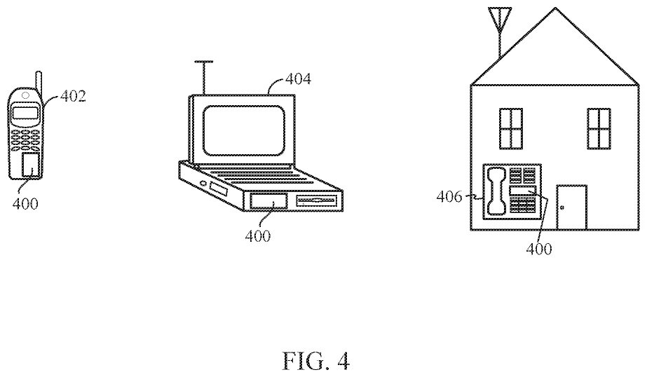

FIG. 4 illustrates various electronic devices that may be integrated with any of the aforementioned systems, apparatus, or methods in accordance with some examples of the disclosure. For example, a mobile phone device 402, a laptop computer device 404, and a fixed location terminal device 406 may include an integrated device 400 as described herein. The integrated device 400 may be, for example, any of the integrated circuits, dies, integrated devices, integrated device packages, integrated circuit devices, device packages, integrated circuit (IC) packages, package-on-package devices described herein. The devices 402, 404, 406 illustrated in FIG. 4 are merely exemplary. Other electronic devices may also feature the integrated device 400 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof.

Various examples have been discussed above with respect to media control based on a viewer's attention. The concepts described herein are applicable to various mediums for presentation visual stimuli. Another such application would he for use in video conferencing, such as Skype™ and WebEx™. For example, optical hardware such as that found in conventional computing devices may be used to track a viewer's vision with respect to the video conferencing presentation on the computing device's screen. An application running on the computing device may then use the data provided by the optical tracking of the viewer's focus to make decisions about the presentation (e.g., begin presentation, stop presentation, pause or temporarily stop presentation, and resume presentation etc.). These decisions may be based on thresholds of attention detection. For instance, the application may begin a presentation if the viewer's focus is maintained on the screen for at least a minimum threshold time (e.g., 2 seconds), the presentation may be stopped if the viewer's focus is other than the screen/presentation for a minimum threshold (e.g., 2 seconds), the presentation may he resumed if the viewer's focus returns to the presentation for a minimum threshold (e.g., 1 second), and stopping the presentation if the viewer's focus is elsewhere for a minimum threshold (e.g., 30 seconds). In addition, a visual and/or audio notification/warning may be given when the viewer's focus is other than the presentation material. This notification may warn them to return their focus to the presentation or it will be stopped, ended, etc. and/or the notification may not be presented until the presentation is already paused or stopped.

In other examples where the presentation is a static type presentation (e.g., terms and conditions of a contract, required reading in a learning course/class, etc.) and cannot be “stopped” or “paused”, the attention based media control may use software and optical hardware to detect the viewer's gaze and, instead of pausing or stopping a static presentation, the media control may grey out the controls or buttons that allow a viewer to move to a next page, accept the terms and conditions, or acknowledge viewing the static presentation. Such a media control system may use thresholds for determining if the viewer's focus has remained on the material for a desired time period. For example, a media based attention control application my grey out (or otherwise present activation) an “accept” button at the bottom of a list of terms and conditions (e.g., for view a website) until the application has detected or determined that the viewer has maintained focus on the presentation material for a minimum time threshold (e.g., 10 consecutive seconds of viewing, 20 total seconds of viewing etc.). In addition, the optical hardware may he configured to detect horizontal and vertical movement, such as a viewer reading a line of text and moving to the next line of text. Based on how much time the viewer is detected reading each line (horizontal times) and each page (vertical times), the application may allow the viewer to continue/finish by activating the controls or buttons or provide a warning that the viewer must do more (read second paragraph) and possibly highlight text the viewer has not been detected reading or reading long enough.

It will be appreciated that various aspects disclosed herein can be described as functional equivalents to the structures, materials and/or devices described and/or recognized by those skilled in the art. For example, in one aspect, an apparatus may comprise a memory (see, e.g., 332 in FIG. 3), means for computing (see, e.g., 301 in FIG. 3) coupled to the memory; means for displaying (see, e.g., 326 in FIG. 3) coupled to the means for computing; means for sensing (see, e.g., 331 in FIG. 3) coupled to the means for computing. The means for computing may be configured to: present visual stimuli on the means for displaying; monitor a viewing focus of a viewer with the means for sensing; determine if the viewing focus of the viewer is on the visual stimuli; stop the visual stimuli when the viewing focus is determined to be other than on the visual stimuli; and resume the visual stimuli when the viewing focus is determined to be on the visual stimuli. It will be appreciated that the aforementioned aspects are merely provided as examples and the various aspects claimed are not limited to the specific references and/or illustrations cited as examples.

One or more of the components, processes, features, and/or functions illustrated in

FIGS. 1-4 may be rearranged and/or combined into a single component, process, feature or function or incorporated in several components, processes, or functions. Additional elements, components, processes, and/or functions may also be added without departing from the disclosure. In some implementations, FIGS. 1-4 and its corresponding description may be used to manufacture, create, provide, and/or produce integrated devices.

As used herein, the terms “smartphone”, “user equipment” (or “UE”), “user device,” “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device that can receive wireless communication and/or navigation signals. These terms include, but are not limited to, a music player, a video player, an entertainment unit, a navigation device, a communications device, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). These terms are also intended to include devices which communicate with another device that can receive wireless communication and/or navigation signals such as by short-range wireless, infrared, wireline connection, or other connection, regardless of whether satellite signal reception, assistance data reception, and/or position-related processing occurs at the device or at the other device. In addition, these terms are intended to include all devices, including wireless and wireline communication devices, that are able to communicate with a core network via a radio access network (RAN), and through the core network the UEs can be connected with external networks such as the Internet and with other UEs. Of course, other mechanisms of connecting to the core network and/or the Internet are also possible for the UEs, such as over a wired access network, a wireless local area network (WLAN) (e.g., based on IEEE 802.11, etc.) and so on. UEs can be embodied by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink forward traffic channel,

The wireless communication between electronic devices can be based on different technologies, such as code division multiple access (CDMA), W-CDMA, time division multiple access (TDMA), frequency division multiple access (FDMA), Orthogonal Frequency Division Multiplexing (OFDM), Global System for Mobile Communications (GSM), 3GPP Long Term Evolution (LTE), Bluetooth (BT), Bluetooth Low Energy (BLE), IEEE 802.11 (WiFi), and IEEE 802.15.4 (Zigbee/Thread) or other protocols that may be used in a wireless communications network or a data communications network. Bluetooth Low Energy (also known as Bluetooth LE, BLE, and Bluetooth Smart) is a wireless personal area network technology designed and marketed by the Bluetooth Special interest Group intended to provide considerably reduced power consumption and cost while maintaining a similar communication range. BLE was merged into the main Bluetooth standard in 2010 with the adoption of the Bluetooth Core Specification Version 4.0 and updated in Bluetooth 5 (both expressly incorporated herein in their entirety).

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Those skilled in the art will appreciate that information and signals may be represented using any of a variety of different technologies and techniques. For example, data, instructions, commands, information, signals, bits, symbols, and chips that may be referenced or implied throughout the above description may be represented by voltages, currents, electromagnetic waves, magnetic fields or particles, optical fields or particles, or any combination thereof

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g,, a combination of a DSP and a microprocessor, a plurality of microprocessors, one or more microprocessors in conjunction with a DSP core, or other such configurations). Additionally, these sequence of actions described herein can be considered to be incorporated entirely within any form of computer-readable storage medium having stored therein a corresponding set of computer instructions that upon execution would cause an associated processor to perform the functionality described herein. Thus, the various aspects of the disclosure may he incorporated in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be incorporated directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art including non-transitory types of memory or storage mediums. An exemplary storage medium is coupled to the processor such that the processor can read information from, and write information to, the storage medium. In the alternative, the storage medium may be integral to the processor.

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or a plurality of claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can he implemented by a device comprising means for performing the respective actions of this method.

Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

1. A method for monitoring eye movement of a viewer, comprising:
presenting visual stimuli on a screen, the visual stimuli comprising a plurality of objects;
monitoring a viewing focus of a viewer;
determining if the viewing focus of the viewer is on at least one of the plurality of objects in the visual stimuli;
stopping the presenting the visual stimuli when the viewing focus is determined to be other than on the visual stimuli; and
resuming the presenting the visual stimuli when the viewing focus is determined to be on the screen.

2. The method of claim 1, further comprising providing a notice to the viewer when the viewing focus of the viewer is determined to be other than on the visual stimuli.

3. The method of claim 1, further comprising determining if the viewer is an authorized viewer based on a facial recognition and preventing the presentation of the visual stimuli when the viewer is determined to not be the authorized viewer.

4. The method of claim 1, further comprising determining if the viewer is in front of the screen and beginning the presentation of the visual stimuli when the viewer is determined to be in front of the screen.

5. The method of claim 1, further comprising determining which of the plurality of objects the viewer is focusing on.

6. The method of claim 1, further comprising determining a duration the viewing focus of the viewer is on the visual stimuli.

7. The method of claim 1, further comprising determining a duration the viewing focus of the viewer is not on the visual stimuli, wherein the stopping the presenting visual stimuli is based on the duration exceeding a predetermined threshold.

8. The method of claim 1, wherein the stopping the presenting the visual stimuli comprises blanking the screen displaying the visual stimuli.

9. A non-transitory computer-readable medium comprising instructions that when executed by a processor cause the processor to perform a method comprising:
presenting visual stimuli on a screen, the visual stimuli comprising a plurality of objects;
monitoring a viewing focus of a viewer;
determining if the viewing focus of the viewer is on at least one of the plurality of objects in the visual stimuli;
stopping the presenting the visual stimuli when the viewing focus is determined to be other than on the visual stimuli; and
resuming the presenting the visual stimuli when the viewing focus is determined to be on the screen.

10. The non-transitory computer-readable medium of claim 9, the method further comprising providing a notice to the viewer when the viewing focus of the viewer is determined to be other than on the visual stimuli.

11. The non-transitory computer-readable medium of claim 9, the method further comprising determining if the viewer is an authorized viewer based on a facial recognition and preventing the presentation of the visual stimuli when the viewer is determined to not be the authorized viewer.

12. The non-transitory computer-readable medium of claim 9, the method further comprising determining if the viewer is in front of the screen and beginning the presentation of the visual stimuli when the viewer is determined to be in front of the screen.

13. The non-transitory computer-readable medium of claim 9, the method further comprising determining which of the plurality of objects the viewer is focusing on.

14. The non-transitory computer-readable medium of claim 9, the method further comprising determining a duration the viewing focus of the viewer is on the visual stimuli.

15. The non-transitory computer-readable medium of claim 9, the method further comprising determining a duration the viewing focus of the viewer is not on the visual stimuli, wherein the stopping the presenting the visual stimuli is based on the duration exceeding a predetermined threshold.

16. The non-transitory computer-readable medium of claim 9, wherein stopping the presenting the visual stimuli comprises blanking the screen displaying the visual stimuli.

17. An apparatus for monitoring eye movement of a viewer, comprising:
a memory;
a processor coupled to the memory;
a screen coupled to the processor;
a sensor coupled to the processor;
wherein the processor is configured to:
present visual stimuli on the screen, the visual stimuli comprising a plurality of objects;
monitor a viewing focus of a viewer with the sensor;
determine if the viewing focus of the viewer is on at least one of the plurality of objects in the visual stimuli;
stop the presentation of the visual stimuli when the viewing focus is determined to be other than on the visual stimuli; and
resume the presentation of the visual stimuli when the viewing focus is determined to be on the screen.

18. The apparatus of claim 17, wherein the processor is further configured to provide a notice to the viewer when the viewing focus of the viewer is determined to be other than on the visual stimuli.

19. The apparatus of claim 17, wherein the processor is further configured to determine if the viewer is an authorized viewer based on a facial recognition and prevent the presentation of the visual stimuli when the viewer is determined to not be the authorized viewer, and wherein the sensor is a camera.

20. The apparatus of claim 17, wherein the processor is further configured to determine if the viewer is in front of the screen and begin the presentation of the visual stimuli when the viewer is determined to be in front of the screen.

21. The apparatus of claim 17, wherein the processor is further configured to determine which of the plurality of objects the viewer is focusing on.

22. The apparatus of claim 17, wherein the processor is further configured to determine a duration the viewing focus of the viewer is on the visual stimuli.

23. The apparatus of claim 17, wherein the processor is further configured to determine a duration the viewing focus of the viewer is not on the visual stimuli, wherein the visual stimuli is stopped based on when the duration exceeds a predetermined threshold.

24. The apparatus of claim 17, wherein the stopping the presenting the visual stimuli comprises blanking the screen displaying the visual stimuli.

25. An apparatus for monitoring eye movement of a viewer, comprising:
a memory;
means for computing coupled to the memory;
means for displaying coupled to the means for computing;
means for sensing coupled to the means for computing;
wherein the means for computing is configured to:
present visual stimuli on the means for displaying, the visual stimuli comprising a plurality of objects;
monitor a viewing focus of a viewer with the means for sensing;
determine if the viewing focus of the viewer is on at least one of the plurality of objects in the visual stimuli;
stop the presentation of the visual stimuli when the viewing focus is determined to be other than on the visual stimuli; and
resume the visual stimuli when the viewing focus is determined to be on the screen.

26. The apparatus of claim 25, wherein the means for computing is further configured to provide a notice to the viewer when the viewing focus of the viewer is determined to be other than on the visual stimuli.

27. The apparatus of claim 25, wherein the means for computing is further configured to determine if the viewer is an authorized viewer based on a facial recognition and prevent the presentation of the visual stimuli when the viewer is determined to not be the authorized viewer.

28. The apparatus of claim 25, wherein the means for computing is further configured to determine if the viewer is in front of the means for displaying and begin the presentation of the visual stimuli when the viewer is determined to be in front of the means for displaying.

29. The apparatus of claim 25, wherein the means for computing is further configured to determine which of the plurality of objects the viewer focuses on.

30. The apparatus of claim 25, wherein the means for computing is further configured to determine a duration the viewing focus of the viewer is on the visual stimuli.
